(19) United States
(12) Patent Application Publication
(10) Pub. No.: US 2023/0066260 A1
(43) Pub. Date: Mar. 2, 2023

(54) MEDIA RECLAIM SYSTEM AND WORKPIECE PROCESSING ASSEMBLY

(71) Applicant: Engineered Abrasives Inc., Alsip (US)

(72) Inventor: Michael J. Wern, Alsip, IL (US)

(21) Appl. No.: 17/823,346

(22) Filed: Aug. 30, 2022

Related U.S. Application Data
(63) Continuation of application No. 17/672,360, filed on Feb. 15, 2022.
(60) Provisional application No. 63/239,882, filed on Sep. 1, 2021.

(51) Int. Cl. B24C 9/00; B03C 1/12; B07B 7/06; B07B 9/00

(52) U.S. Cl. CPC B24C 9/006; B03C 1/12; B07B 7/06; B07B 9/00; B03C 2201/28; B03C 2201/20

(57) ABSTRACT

A workpiece processing assembly comprising including a media collection device that is adapted to receive used media from a media blasting chamber. A transport mechanism, coupled to the media collection device, transports used media to a media reclaim system. A first separation device is used to perform a filtering process on the used media to separate non-usable media from usable media. A second separation device is configured to apply a magnetic field to the usable media to create recycled media for use in the media blasting chamber.

### CROSS-REFERENCE TO RELATED APPLICATION

This patent application claims priority to, and is a continuation of U.S. patent application Ser. No. 17,672,360, filed Feb. 15, 2022, which claims priority to and the benefit of pending provisional patent application 63/239,882 filed Sep. 1, 2021, which is incorporated herein by reference in its entirety.

### BACKGROUND

When media blasting a workpiece, such as a gear, the workpiece is placed in a closed chamber and the blasting system is actuated, whereby media are mixed with air. After mixing the media and air, a stream of the air/media mixture is directed against the workpiece, often through increased or high-speed application. This process is referred to as peening. The peening process is configured to affect and change the characteristics of the surface of the workpiece, and in particular increase the strength of the workpiece. Accordingly, media blasting a workpiece improves the durability of a workpiece. An example of peening is described in U.S. Pat. No. 5,272,897, and the disclosure of the U.S. Pat. No. 5,272,897 is hereby incorporated in its entirety by this reference. Other exemplary methods of media blasting and finishing are provided in U.S. Pat. Nos. 8,453,305 and 10,773,358, which are hereby incorporated in their entirety by this reference.

As part of the peening process, the peening media may be recycled and reused. However, due to the force/speed of the peening process, not all of the peening media will be suitable for reuse. Some of the peening media will degrade because particles of peening break off or become lodged on the surface of the workpieces. Also, particles from the part being processed may break off and be retained in the used peening media. Accordingly, before the peening media can be reused it is filtered and separated such that only material of a certain size is recycled and reused in the peening process. However, even after this filtering is performed, small (including microscopic) pieces of workpiece material and degraded peening media may remain in the peening media. Accordingly, what is needed are systems and methods for post-processing of peening media to remove particulate matter.

This background information is provided to offer some information believed by the applicant to be of possible relevance to the present disclosure. No admission is intended, nor should such admission be inferred or construed, that any of the preceding information constitutes prior art against the present disclosure. Other aims, objects, advantages, and features of the disclosure will become more apparent upon reading the following non-restrictive description of specific embodiments thereof, given by way of example only with reference to the accompanying drawings.

### OBJECTS AND SUMMARY

An object of the present application is to remove or reduce non-usable particulate matter from recycled peening media used in a peening process. In illustrative embodiments, the peening media is collected after it is used in a peening process. The peening media undergoes a multi-step cleaning process after it is used in peening to remove or reduce undesirable particles or particulates that are present in the peening media.

These and other advantages and features will become more apparent from the following description taken in conjunction with the drawings.

### BRIEF DESCRIPTION OF THE DRAWINGS

The present specification will be described with reference to the accompanying drawings, in which:

FIG. 1 depicts an exemplary media reclaim system for collecting media following the treating of a workpiece according to the media blasting process of a media blasting apparatus, according to one or more embodiments;

FIG. 2 depicts an exemplary first separation device, according to one or more embodiments;

FIG. 3A depicts an exemplary second separation device, according to one or more embodiments; and

FIG. 3B depicts the exemplary second separation device of FIG. 3A in an open position, according to one or more embodiments.

### DETAILED DESCRIPTION OF EMBODIMENTS

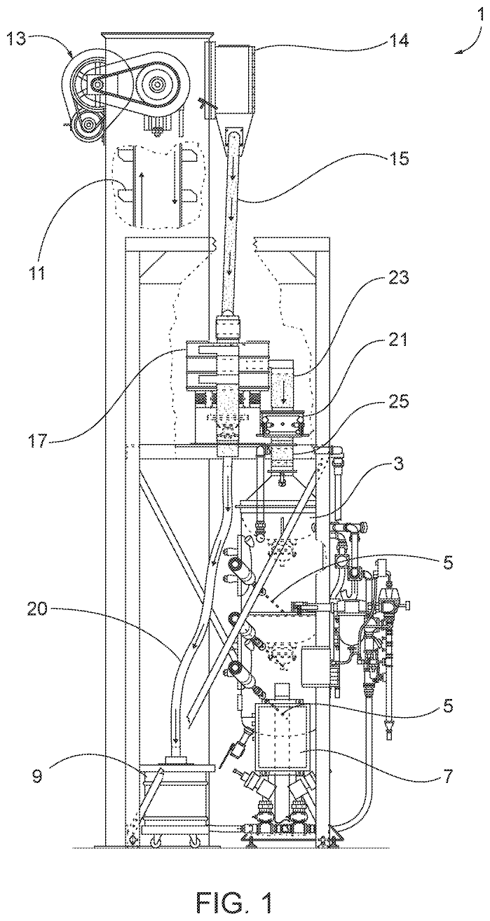

Referring now to FIG. 1, a media reclaim system 1 according to the one aspect of the application, generally indicated by the number.

The media blasting apparatus will now be described. The media blasting apparatus includes a blasting chamber 3 or cabinet, in which a stream of media is directed against a workpiece. Such media may comprise, for example, cut wire, glass beads, ceramic beads or fine steel beads. As the media engages with the surface of the workpiece, microscopic or small particles from the media may be retained or lodged into the surface of the workpiece due to the force and direction of the blasting stream 5.

The blasting chamber 3 is connected to a media collection device 11 for collecting the media that fall after collision with the workpiece. The fallen media may include broken pieces of media that have been recycled, as well as virgin or unbroken pieces, and particles from the workpiece. Media of sufficient size is reclaimed in this system, as discussed below, and mixed with virgin media to be reused in the blasting operation. Accordingly, it is understood that media that is reused should not include pieces of media that are undesirable for the further peening process.

A media transport device 13 includes a media collection device 11 from a media blasting chamber 3 for moving media to a media reclaim system 1. The media collection device 11 collects media and moves it to the media reclaim system 1. The media transport device 13 may continuously collect and move fallen media as the media blasting process is performed.

In one example, the media transport device 13 is an elevator system including a media collection device having one or more buckets for transporting fallen media to the media reclaim system 1 via at least one bucket. The media transport device 13 also includes a belt drive system to vertically drive at least one bucket from the media collection device 11 to the media reclaim system 1. The at least one bucket may be immersed into the media collection device 11 where it is filled with fallen media. The fallen media is transported to the media reclaim system 1 where it is emptied into a funnel assembly 14. The belt drive system then drives the at least one bucket back of the media collection device 11 to be refilled with fallen media.

As another example, the fallen media may be transported by media collection device 11 to the media reclaim system 1 via air. For example, the media transport device 13 may include a pressurized air supply. The pressurized air supply may provide an air flow to the media forcing the collected fallen media up through a conduit to the funnel assembly and into the media reclaim system 1.

The media reclaim system 1 includes a conduit 15 for conveying collected media from funnel assembly 14 to a first separation device 17. The first separation device 17 may separate the fallen media into non-usable and usable media. Non-usable media may be routed through a conduit 20 to a waste receptacle 9. In some embodiments, usable media may be routed through a conduit 23 to be immediately reused. In other embodiments, the usable media may be routed through a conduit 23 to a second separation device 21 (e.g., via an inlet) before being reused.

In one or more embodiments, the second separation device 21 may be connected to a double pressure chamber 7. The double pressure chamber 7 may be held between 70 and 80 psi. The reclaimed usable media may be delivered from the second separation device 21 (e.g., via an outlet) to the double pressure chamber 7 where the reclaimed usable media are mixed with virgin media. The reclaimed media may be of a mesh size greater than 100 mesh and the virgin media may be of a mesh size between 60 and 100 mesh or even between 60 and 80 mesh. As stated previously, in the present specification, the media of the first medial blasting apparatus may comprise glass, ceramic, or fine steel beads. The virgin media are supplied to the double pressure chamber 7 through a plurality of media supply valves. The double pressure chamber 7 may be coupled to a media sensor monitor for automatically controlling the supply (e.g., a ratio) of virgin media. The supply of virgin media is controlled to ensure adequate peening of the workpiece. Specifically, the supply of the virgin media is controlled to ensure that adequate compression stress is provided to the workpiece so that a sufficiently high fatigue strength is obtained upon blasting. The double pressure chamber 7 may further include a media metering on/off valve.

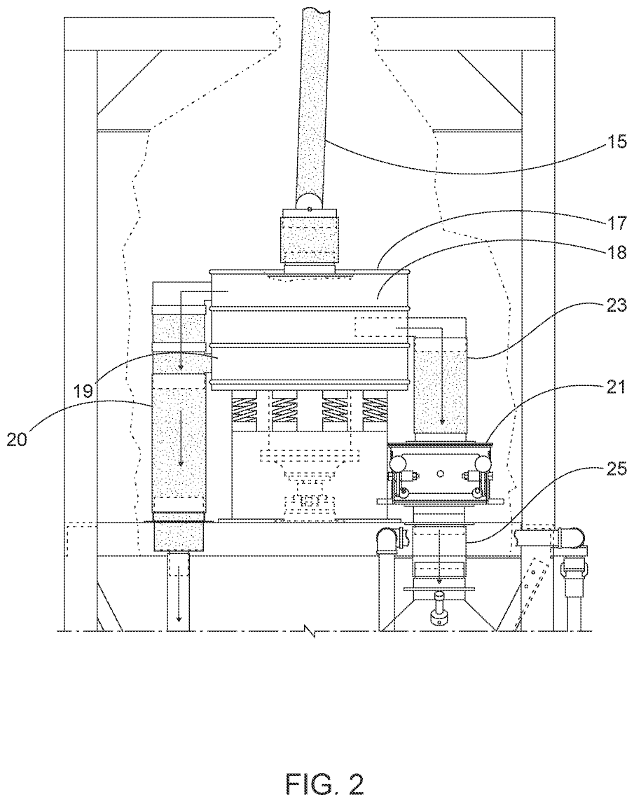

Referring now to FIG. 2, an exemplary first separation device 17 is depicted. The first separation device 17 generally separates the fallen media into usable media (e.g., media of sufficiently large size to be effective in a future peening operation). Such usable media may be unbroken media and broken media of sufficient size for use in a peening operation. Non-usable media may be fines or dust which cannot be reused in a future peening operation. The first separation device 17 may be configured to route usable media back to the media blasting apparatus. The first separation device 17 may also or instead be configured to route non-usable media to the waste receptacle 9.

The first separation device 17 may be a two-deck system comprising a top screen 18 and a bottom screen 19. In one or more embodiments, the top screen 18 is between 20 and 40 mesh gauge. In one or more embodiments, the bottom screen 19 is between 170 and 200 mesh gauge.

In one or more embodiments, the separator screens 18, 19, in one example, are constantly vibrated to increase the efficiency of separation. In one or more embodiments, non-usable media is transported by a conduit 20 to the waste receptacle 9.

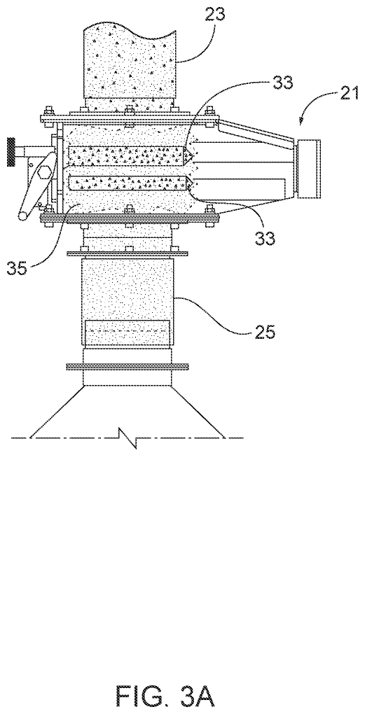

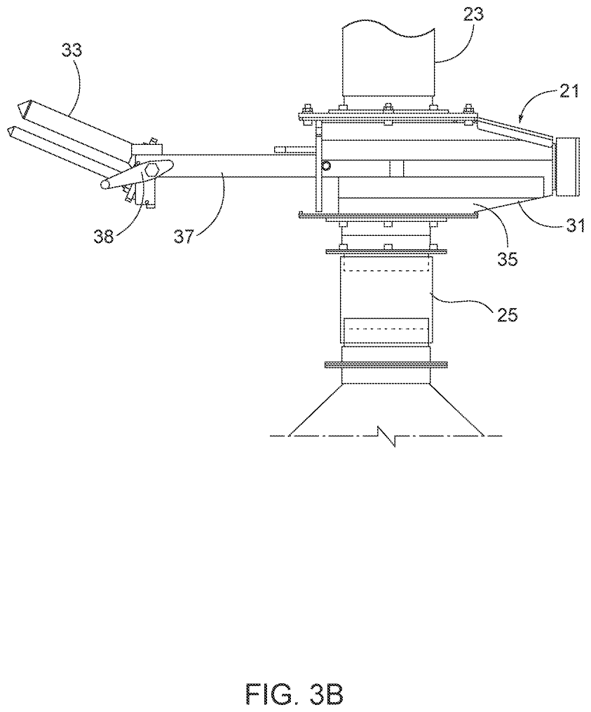

Referring now to FIG. 3A, an exemplary second separation device 21 is depicted. The second separation device 21 may be used to perform a second separation operation on the fallen media. In one or more embodiments, reusable fallen media may be transported via conduit 23 from the first separation device 17 to the second separation device 21.

Despite the fallen media undergoing a first separation operation through employment of first separation device 17, it is possible that there may be additional small particles or dust attached to or commingled with the reusable fallen media. For example, the fallen media may include small particles or dust having metallic pieces that broke or otherwise separated from the workpiece during a peening operation. As another example, if metallic peening media is used, the small particles or dust may comprise pieces of metallic peening media or dust that have been created through degradation of the media during a peening operation. Accordingly, second separation device 21 is configured to remove such small particles and dust from the fallen media.

The second separation device 21 may include a magnetic separator device employing at least one magnet 33 to remove such small particles and dust from the usable media. The at least one magnet 33 may be grate magnet assemblies. As the usable media passes by the at least one magnet 33, small particles and dust may be attracted to the at least one magnet 33 and adhere to the surface. In one application, utilizing glass peening media, the at least one magnet may attract any metal particles or dust that has been introduced into the fallen media by collision of the peening media with a workpiece.

The at least one magnet 33 may be disposed within a housing 35. The housing 35 may include a top side, a bottom side, and opposing sidewalls. The top side may include an inlet coupled to an outlet of the first separation device 17 for receiving usable media. The bottom side may include an outlet coupled to an inlet of a double pressure chamber 7. The at least one magnet 33 may extend between two opposing sidewalls.

Referring now to FIG. 3B, the second separation device 21 is depicted in an open position. The second separation device 21 may also include a tray 37. The at least one magnet 33 may be positioned on a tray 37, which may slide in and out of housing 35. When the tray 37 is in the housing, the at least one magnet 33 is in an operative position for removing material from the fallen media. At a certain point, the at least one magnet 33 may become saturated with material and must be removed from the housing 35 for cleaning. To remove the at least one magnet 33, the tray 37 may be withdrawn and/or extended from the housing 35. The tray 37 may include one or more engagement mechanisms 38 for retaining the at least one magnet 33. The engagement mechanisms 38 may be adjusted to remove one or more magnets of the at least one magnet 33 for cleaning and/or replacement.

In one example, different magnets may be introduced into the second separation device 21 depending on the type of peening media and the type of workpiece. For instance, stronger magnets may be used to attract larger particles and smaller magnets may be used to attract smaller particles depending on the tolerance of the particular peening operation for particles of various sizes.

Methods of media blasting and finishing for gears disclosed herein may be with respect to a hold down apparatus, but it is contemplated that other conventional part holders and blasting apparatuses may also be used with the steps described herein. The above discussed process recognizes that most often gears need steel peening at the gear root to prevent fatigue bending in the root radius.

The applicant has provided description and figures that are intended as an illustration of certain embodiments of the subject technology and are not intended to be construed as containing or implying limitation of the subject technology to those embodiments. It will be appreciated that, although applicant has described various aspects of the subject technology with respect to specific embodiments, various alternatives and modifications will be apparent from the present disclosure, which are within the spirit and scope of the present specification.

What is claimed is:

1. A workpiece processing assembly comprising:
a media blasting chamber for processing a workpiece;
a media collection device adapted to receive used media from the media blasting chamber; and
a transport mechanism, coupled to the media collection device, that transports the used media to a media reclaim system, wherein the media reclaim system comprises:
a first separation device configured to perform a filtering process on the used media to separate the used media into non-usable media and usable media; and
a second separation device configured to apply a magnetic field to the usable media to create recycled media for use in the media blasting chamber.

2. The workpiece processing assembly of claim 1, wherein the second separation device applies an electromagnetic field to the usable media.

3. The workpiece processing assembly of claim 1, wherein the second separation device applies a magnetic field through employment of at least one magnet.

4. The workpiece processing assembly of claim 3, wherein the second separation device applies a magnetic field through employment of at least two magnets.

5. The workpiece processing assembly of claim 4, wherein the second separation device is a grate magnet assembly.

6. The workpiece processing assembly of claim 5, wherein the grate magnet assembly includes a housing and a tray slidable within the housing.

7. The workpiece processing assembly of claim 6, wherein the housing comprises a top side, a bottom side, and two opposing sidewalls.

8. The workpiece processing assembly of claim 7, wherein the top side includes an inlet that is coupled to an outlet of the first separation device.

9. The workpiece processing assembly of claim 7, wherein the bottom side includes an outlet that is coupled to an inlet of a pressure chamber.

10. The workpiece processing assembly of claim 7, wherein the at least one magnet is disposed within the tray and extends between the two opposing sidewalls.

11. A media reclaim system to process used media from a media blasting chamber for reuse in the media blasting chamber, the media reclaim system comprising:
a first separation device configured to perform a filtering process on used media to separate the used media into non-usable media and usable media; and
a second separation device configured to apply a magnetic field to the usable media to create recycled media for use in the media blasting chamber.

12. The media reclaim system of claim 11, wherein the second separation device applies an electromagnetic field to the usable media.

13. The media reclaim system of claim 11, wherein the second separation device applies a magnetic field through employment of at least one magnet.

14. The media reclaim system of claim 13, wherein the second separation device is a grate magnet assembly.

15. The media reclaim system of claim 14, wherein the grate magnet assembly includes a housing and a tray slidable within the housing.

16. The media reclaim system of claim 15, wherein the housing comprises a top side, a bottom side, and two opposing sidewalls.

17. The media reclaim system of claim 16, wherein the top side includes an inlet that is coupled to an outlet of the first separation device.

18. The media reclaim system of claim 16, wherein the bottom side includes an outlet that is coupled to an inlet of a pressure chamber.

19. A media reclaim system to process used media from a media blasting chamber for reuse in the media blasting chamber, the media reclaim system comprising:
a first separation device configured to perform a filtering process on used media to separate the used media into non-usable media and usable media;
a first conduit, coupled to the first separation device, configured to route the non-usable media to a waste receptacle;
a second separation device configured to apply a magnetic field to the usable media to create recycled media for use in the media blasting chamber;
a second conduit, coupled to the first separation device and the second separation device, that routes the usable media to the second separation device; and
a third conduit, coupled to the second separation device and the media blasting chamber, that routes the recycled media to the media blasting chamber.

20. The media reclaim system of claim 19, further comprising a media sensor monitor coupled to the media blasting chamber configured to automatically control a ratio of recycled media to virgin media.
